(19) United States
(12) Patent Application Publication
(10) Pub. No.: US 2023/0124629 A1
(43) Pub. Date: Apr. 20, 2023

(54) ELECTRONIC DEVICE

(71) Applicant: Innolux Corporation, Miao-Li County (TW)

(72) Inventor: Kazuyuki Hashimoto, Miao-Li County (TW)

(73) Assignee: Innolux Corporation, Miao-Li County (TW)

(21) Appl. No.: 17/862,409

(22) Filed: Jul. 12, 2022

Related U.S. Application Data
(60) Provisional application No. 63/257,575, filed on Oct. 20, 2021.

(51) Int. Cl. G09G 3/36

(52) U.S. Cl. CPC G09G 3/3688; G09G 2300/0852

(57) ABSTRACT

An electronic device is provided. The electronic device includes a plurality of units. at least one of the plurality of units includes a driving circuit and a working element. The working element is coupled to the driving circuit, and driven by the driving circuit. The driving circuit receives a first data signal and a second data signal during a scan period.

### CROSS-REFERENCE TO RELATED APPLICATION

This application claims the priority benefits of U.S. provisional application Ser. No. 63/257,575, filed on Oct. 20, 2021. The entirety of the above-mentioned patent application is hereby incorporated by reference herein and made a part of this specification.

### BACKGROUND

### Technical Field

The disclosure relates a device; particularly, the disclosure relates to an electronic device.

### Description of Related Art

In the antenna application or the light emitting unit with liquid-crystal application, the bias voltage of varactor or the light emitting unit is limited by the source driver integrated circuit (IC) output voltage range. For example, in the antenna application, the varactor bias range may be expected around 20 volts, but the driving voltage of the source driver IC may only 16 volts. In the LCD application, the polymer-dispersed liquid crystal (PDLC) cell and the polymer network liquid crystal (PNLC) cell for smart window and transparent display need more than 10 volts of the bias voltage for optimum optical performance, but the driving voltage of the source driver IC commonly used in LCD application may only 5 volts. Therefore, how to generate a higher driving voltage without redesigning the source driver IC is a problem that needs to be solved at present.

### SUMMARY

The electronic device of the disclosure includes a plurality of units. At least one of the plurality of units includes a driving circuit and a working element. The working element is coupled to the driving circuit, and driven by the driving circuit. The driving circuit receives a first data signal and a second data signal during a scan period.

Based on the above, according to the electronic device of the disclosure, the electronic device can drive the working element with a wide voltage range.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of the disclosure.

FIG. 2 is a schematic timing diagram of a plurality of voltages and signals according to the embodiment of FIG. 1 of the disclosure.

FIG. 3 is a schematic diagram of an electronic device according to an embodiment of the disclosure.

FIG. 4 is a schematic timing diagram of a plurality of voltages and signals according to the embodiment of FIG. 3 of the disclosure.

FIG. 5 is a schematic diagram of an electronic device according to an embodiment of the disclosure.

FIG. 6 is a schematic timing diagram of a plurality of voltages and signals according to the embodiment of FIG. 5 of the disclosure.

FIG. 7 is a schematic diagram of an electronic device according to a first application embodiment of the disclosure.

FIG. 8 is a schematic diagram of an electronic device according to a second application embodiment of the disclosure.

FIG. 9 is a schematic diagram of an electronic device according to a third application embodiment of the disclosure.

FIG. 10 is a schematic diagram of an electronic device according to a fourth application embodiment of the disclosure.

FIG. 11 is a schematic diagram of an electronic device according to an embodiment of the disclosure.

FIG. 12 is a schematic timing diagram of a plurality of voltages and signals according to the embodiment of FIG. 11 of the disclosure.

FIG. 13 is a schematic diagram of an electronic device according to an embodiment of the disclosure.

FIG. 14 is a schematic timing diagram of a plurality of voltages and signals according to the embodiment of FIG. 13 of the disclosure.

FIG. 15 is a schematic diagram of an electronic device according to an embodiment of the disclosure.

FIG. 16 is a schematic timing diagram of a plurality of voltages and signals according to the embodiment of FIG. 15 of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

The electronic device of the disclosure may be a display device or an antenna device, but the disclosure is not limited thereto. In some embodiment of the disclosure, the electronic device of the disclosure may, for example, be adapted to an active matrix light emitting diode (AM-LED), a liquid crystal, a light emitting diode, a quantum dot (QD), a fluorescence, a phosphor, a variable capacitor, other suitable display medium, or the combination of the aforementioned material, but the disclosure is not limited thereto. The light emitting diode may include, for example, organic light emitting diode (OLED), sub-millimeter light emitting diode (Mini LED), micro light emitting diode (Micro LED), or quantum dot light emitting diode (QLED or QDLED) or other suitable materials. The materials may be arranged and combined arbitrarily, but the disclosure is not limited to thereto. The electronic device of the disclosure may include peripheral systems such as a driving system, a control system, a light source system, a communication system, a shelf system, and the like to support a working element of the electronic device.

It should be noted that in the following embodiments, the technical features of several different embodiments may be replaced, recombined, and mixed without departing from the spirit of the disclosure to complete other embodiments. As long as the features of each embodiment do not violate the spirit of the disclosure or conflict with each other, they may be mixed and used together arbitrarily.

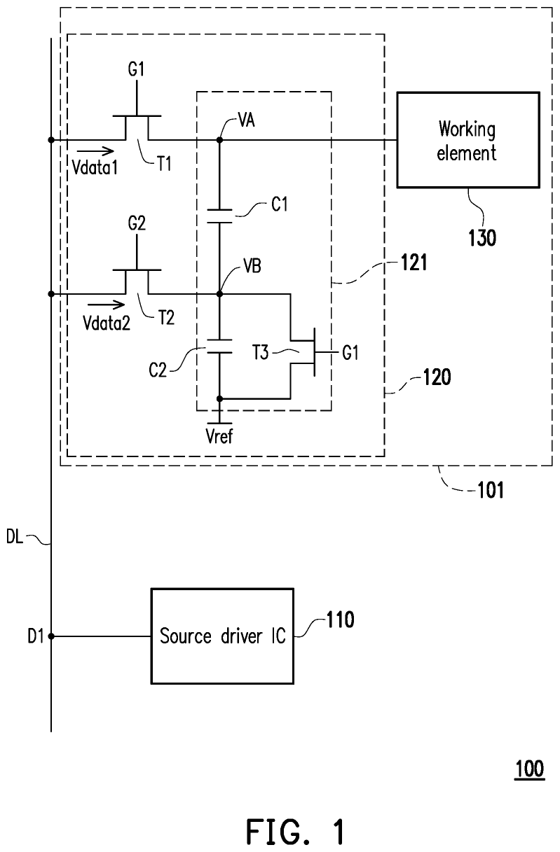

FIG. 1 is a schematic diagram of an electronic device according to an embodiment of the disclosure. Referring to FIG. 1, the electronic device 100 includes a plurality of units, a source driver integrated circuit (IC) 110, and a data line DL. At least one of the plurality of units may be configured as unit 101. The unit 101 includes a driving circuit 120 and a working element 130. The working element 130 may be a voltage-controlled circuit, such as an LED driver unit or an antenna unit. In the embodiment of the disclosure, the working element 130 is coupled to the driving circuit 120. The source driver IC 110 is coupled to the driving circuit 120 through the data line DL, and provides a data signal D1 to the driving circuit 120 through the data line DL. The working element 130 is driven by the driving circuit 120. The driving circuit 120 may receive a first data signal and a second signal during a scan period.

In the embodiment of the disclosure, the driving circuit 120 may include a first transistor T1, a second transistor T2, and a voltage adder 121. The voltage adder 121 may include a first capacitor C1, a second capacitor C2, and a third transistor T3. A first terminal of the first transistor T1 is coupled to the data line DL, and a second terminal of the first transistor T1 is coupled to a first circuit node. A first terminal of the second transistor T2 is coupled to the data line DL, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 130 is coupled to the first circuit node. In the embodiment of the disclosure, the first transistor T1, the second transistor T2, and the third transistor T3 may be an N-type transistor, respectively.

In the embodiment of the disclosure, the driving circuit 120 may sequentially receive the first data signal having a data voltage “Vdata1” and the second data signal having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal having the data voltage “Vdata1” and the second data signal having the data voltage “Vdata2” to the voltage adder 121 by respectively receiving the data signal D1 according to the first control signal G1 and the second control signal G2. The voltage adder 121 may output a driving signal to the working element 130. Therefore, the working element 130 is driven by the driving signal, and the driving signal has a voltage higher than the data voltage “Vdata1” of the first data signal and the data voltage “Vdata2” of the second data signal.

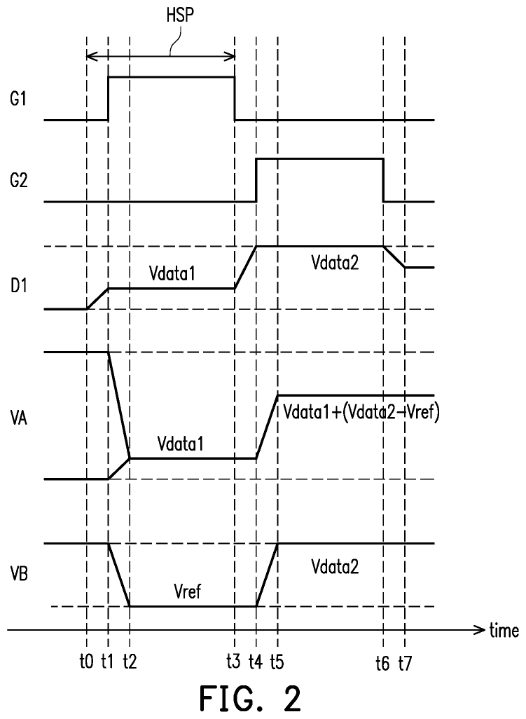

FIG. 2 is a schematic timing diagram of a plurality of voltages and signals according to the embodiment of FIG. 1 of the disclosure. Referring to FIG. 1 and FIG. 2, the plurality of voltages and signals associated with the electronic device 100 of FIG. 1 may be implemented as shown in the timing diagram of FIG. 2. In the embodiment of the disclosure, the source driver IC 110 may output the data signal D1 to the data line DL. During the period from time t0 to time t1, the data signal D1 is raised to the data voltage “Vdata1”. During the period from time t1 to time t2, the first control signal G1 is changed to a high voltage level, and the second control signal G2 is maintained at a low voltage level. The data signal D1 is maintained at the data voltage “Vdata1”. Thus, the first transistor T1 is turned-on, the second transistor T2 is turned-off, and the third transistor T3 is turned-on. A node voltage VA of the first circuit node is changed to the data voltage “Vdata1”. A node voltage VB of the second circuit node is changed to the reference voltage Vref.

During the period from time t2 to time t3, the first control signal G1 is maintained at the high voltage level, and the second control signal G2 is maintained at the low voltage level. The node voltage VA of the first circuit node is maintained at the data voltage “Vdata1”. The node voltage VB of the second circuit node is maintained at the reference voltage Vref. The data signal D1 is maintained at the data voltage “Vdata1”. Thus, the first capacitor C1 and the second capacitor C2 are charged during the period from time t2 to time t3.

During the period from time t3 to time t4, the first control signal G1 is changed to the low voltage level, and the second control signal G2 is maintained at the low voltage level. Thus, the first transistor T1, the second transistor T2, and the third transistor T3 are turned-off. The data signal D1 is raised to the data voltage “Vdata2”. Due to the first capacitor C1, the node voltage VA of the first circuit node is maintained at the data voltage “Vdata1”. Due to the second capacitor C2, the node voltage VB of the second circuit node is maintained at the reference voltage Vref.

During the period from time t4 to time t5, the first control signal G1 is maintained at the low voltage level, and the second control signal G2 is changed to the high voltage level. The data signal D1 is maintained at the data voltage “Vdata2”. Thus, the first transistor T1 is turned-off, the second transistor T2 is turned-on, and the third transistor T3 is turned-off. The node voltage VB of the second circuit node is changed to the data voltage “Vdata2”. Due to the node voltage VB of terminal of first capacitor C1 is raised to the data voltage “Vdata2”, the first capacitor C1 is charged, so that the node voltage VA of another terminal of first capacitor C1 is raised to the data voltage “Vdata1+(Vdata2−Vref)”.

During the period from time t5 to time t6, the first control signal G1 is maintained at the low voltage level, and the second control signal G2 is maintained at the high voltage level. The data signal D1 is maintained at the data voltage “Vdata2”. Thus, the first transistor T1 is turned-off, the second transistor T2 is turned-on, and the third transistor T3 is turned-off. The node voltage VB of the second circuit node is maintained at the data voltage “Vdata2”. Due to the node voltage VB of a terminal of first capacitor C1 is maintained at the data voltage “Vdata2”, the node voltage VA of another terminal of first capacitor C1 is maintained at the data voltage “Vdata1+(Vdata2−Vref)”. Therefore, the voltage adder 121 may output the driving signal having the data voltage “Vdata1+(Vdata2−Vref)” to drive the working element 130 through the first circuit node.

During the period from time t6 to time t7, the first control signal G1 is maintained at the low voltage level, and the second control signal G2 is changed to the low voltage level. Thus, the first transistor T1 is turned-off, the second transistor T2 is turned-off, and the third transistor T3 is turned-off. The node voltage VB of the second circuit node is maintained at the data voltage “Vdata2”, and the node voltage VA of the another terminal of first capacitor C1 is maintained at the data voltage “Vdata1+(Vdata2−Vref)”.

In addition, the period from time t0 to time t7 may be one scan period of the electronic device 100. Moreover, due to the source driver IC 110 provides the data signal D1 through the one data line DL for generating the first data signal and the second data signal by the first transistor T1 and the second transistor T2, the period from time t0 to time t3 may be one horizontal scan period HSP of the source driver IC 110 outputting the data signal D1 having the data voltage “Vdata1”, and the period from time t3 to time t6 may be another one horizontal scan period of the source driver IC 110 outputting the data signal D1 having the data voltage “Vdata2”.

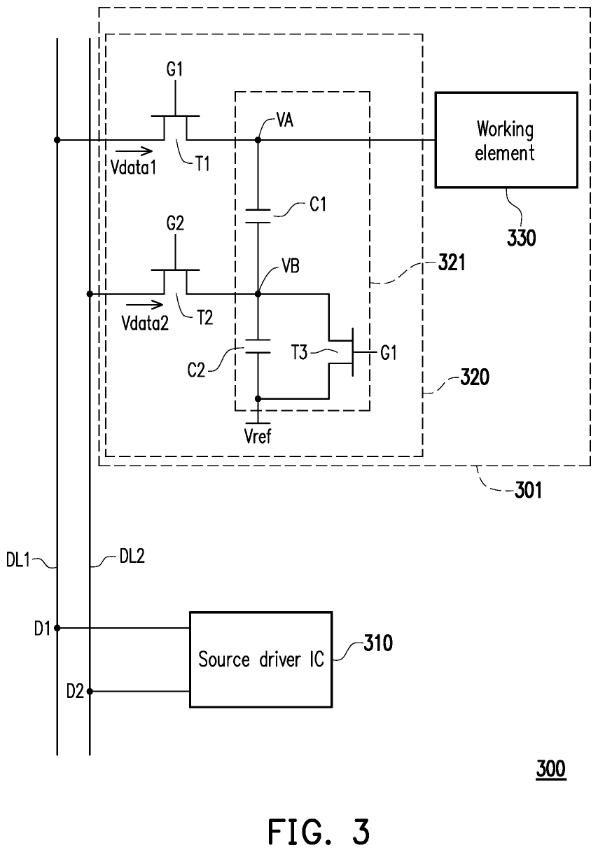

FIG. 3 is a schematic diagram of an electronic device according to an embodiment of the disclosure. Referring to FIG. 3, the electronic device 300 includes a plurality of units, a source driver IC 310, a first date lain DL1 and a second data line DL2. At least one of the plurality of units may be configured as unit 301. The unit 301 includes a driving circuit 320 and a working element 330. The working element 330 may be a voltage-controlled circuit, such as an LED driver unit or an antenna unit. In the embodiment of the disclosure, the working element 330 is coupled to the driving circuit 320. The source driver IC 310 is coupled to the driving circuit 320 through the first data line DL1 and the second data line DL2, and outputs a first data signal D1 and a second data signal D2 to the driving circuit 320 through the first data line DL1 (first terminal) and the second data line DL2 (second terminal). The working element 330 is driven by the driving circuit 320. The driving circuit 320 may receive the first data signal D1 and the second data signal D2 at the same time during a scan period.

In the embodiment of the disclosure, the driving circuit 320 may include a first transistor T1, a second transistor T2, and a voltage adder 321. The voltage adder 321 may include a first capacitor C1, a second capacitor C2, and a third transistor T3. A first terminal of the first transistor T1 is coupled to the first data line DL1 to receive the first data signal D1, and a second terminal of the first transistor T1 is coupled to a first circuit node. A first terminal of the second transistor T2 is coupled to the second data line DL2 to receive the second data signal D2, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 330 is coupled to the first circuit node. In the embodiment of the disclosure, the first transistor T1, the second transistor T2, and the third transistor T3 may be an N-type transistor, respectively.

In the embodiment of the disclosure, the driving circuit 320 may sequentially receive the first data signal D1 having a data voltage “Vdata1” and the second data signal D2 having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal D1 having the data voltage “Vdata1” and the second data signal D2 having the data voltage “Vdata2” to the voltage adder 321 by respectively receiving the first data signal D1 and the second data signal D2 according to the first control signal G1 and the second control signal G2. The voltage adder 321 may output a driving signal to the working element 330. Therefore, the working element 330 is driven by the driving signal, and the driving signal has a voltage higher than the data voltage “Vdata1” of the first data signal D1 and the data voltage “Vdata2” of the second data signal D2.

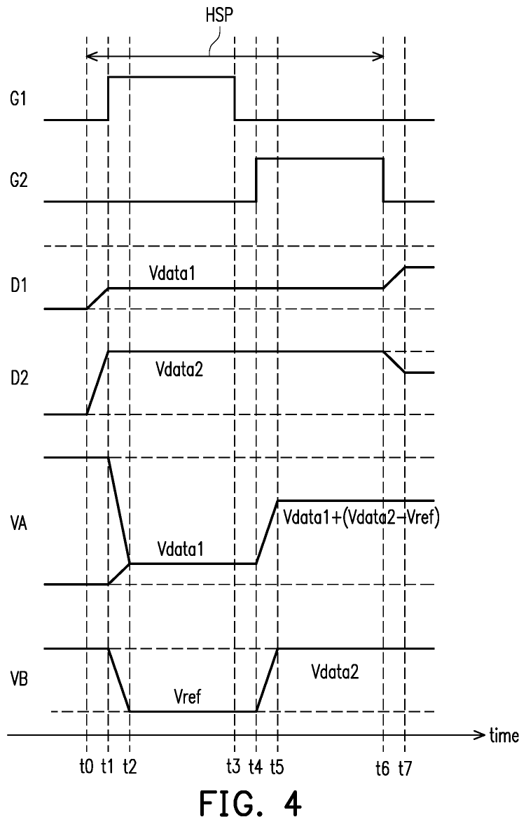

FIG. 4 is a schematic timing diagram of a plurality of voltages and signals according to the embodiment of FIG. 3 of the disclosure. Referring to FIG. 3 and FIG. 4, the plurality of voltages and signals associated with the electronic device 300 of FIG. 3 may be implemented as shown in the timing diagram of FIG. 4. In the embodiment of the disclosure, the source driver IC 310 may output the first data signal D1 and the second data signal D2 to the first data line DL1 and the second data line DL2 at the same time. During the period from time t0 to time t1, the first data signal D1 is raised to the data voltage “Vdata1”, and the second data signal D2 is raised to the data voltage “Vdata2”. During the period from time t1 to time t2, the first control signal G1 is changed to a high voltage level, and the second control signal G2 is maintained at a low voltage level. The first data signal D1 is maintained at the data voltage “Vdata1”. The second data signal D2 is maintained at the data voltage “Vdata2”. Thus, the first transistor T1 is turned-on, the second transistor T2 is turned-off, and the third transistor T3 is turned-on. A node voltage VA of the first circuit node is changed to the data voltage “Vdata1”. A node voltage VB of the second circuit node is changed to the reference voltage Vref.

During the period from time t2 to time t3, the first control signal G1 is maintained at the high voltage level, and the second control signal G2 is maintained at the low voltage level. The node voltage VA of the first circuit node is maintained at the data voltage “Vdata1”. The node voltage VB of the second circuit node is maintained at the reference voltage Vref. The first data signal D1 is maintained at the data voltage “Vdata1”. The second data signal D2 is maintained at the data voltage “Vdata2”. Thus, the first capacitor C1 and the second capacitor C2 are charged during the period from time t2 to time t3.

During the period from time t3 to time t4, the first control signal G1 is changed to the low voltage level, and the second control signal G2 is maintained at the low voltage level. Thus, the first transistor T1, the second transistor T2 and the third transistor T3 are turned-off. The first data signal D1 is maintained at the data voltage “Vdata1”. The second data signal D2 is maintained at the data voltage “Vdata2”. Due to the first capacitor C1, the node voltage VA of the first circuit node is maintained at the data voltage “Vdata1”. Due to the second capacitor C2, the node voltage VB of the second circuit node is maintained at the reference voltage Vref.

During the period from time t4 to time t5, the first control signal G1 is maintained at the low voltage level, and the second control signal G2 is changed to the high voltage level. The first data signal D1 is maintained at the data voltage “Vdata1”. The second data signal D2 is maintained at the data voltage “Vdata2”. Thus, the first transistor T1 is turned-off, the second transistor T2 is turned-on, and the third transistor T3 is turned-off. The node voltage VB of the second circuit node is changed to the data voltage “Vdata2”. Due to the node voltage VB of a terminal of first capacitor C1 is raised to the data voltage “Vdata2”, the first capacitor C1 is charged, so that the node voltage VA of another terminal of first capacitor C1 is raised to the data voltage “Vdata1+(Vdata2−Vref)”.

During the period from time t5 to time t6, the first control signal G1 is maintained at the low voltage level, and the second control signal G2 is maintained at the high voltage level. The first data signal D1 is maintained at the data voltage “Vdata1”. The second data signal D2 is maintained at the data voltage “Vdata2”. Thus, the first transistor T1 is turned-off, the second transistor T2 is turned-on, and the third transistor T3 is turned-off. The node voltage VB of the second circuit node is maintained at the data voltage “Vdata2”. Due to the node voltage VB of the terminal of first capacitor C1 is maintained at the data voltage “Vdata2”, the node voltage VA of the another terminal of first capacitor C1 is maintained at the data voltage “Vdata1+(Vdata2−Vref)”. Therefore, the voltage adder 321 may output the driving signal having the data voltage “Vdata1+(Vdata2−Vref)” to drive the working element 330 through the first circuit node.

During the period from time t6 to time t7, the first control signal G1 is maintained at the low voltage level, and the second control signal G2 is changed to the low voltage level. Thus, the first transistor T1 is turned-off, the second transistor T2 is turned-off, and the third transistor T3 is turned-off. The node voltage VB of the second circuit node is maintained at the data voltage “Vdata2”, and the node voltage VA of the another terminal of first capacitor C1 is maintained at the data voltage “Vdata1+(Vdata2−Vref)”.

In addition, the period from time t0 to time t7 may be one scan period of the electronic device 300. Moreover, due to the source driver IC 310 provides the first data signal D1 and the second data signal D2 through the first data line DL1 and the second data line DL2 at the same time, the period from time t0 to time t6 may be one horizontal scan period HSP of the source driver IC 310 for outputting the first data signal D1 having the data voltage “Vdata1” and the second data signal D2 having the data voltage “Vdata2”.

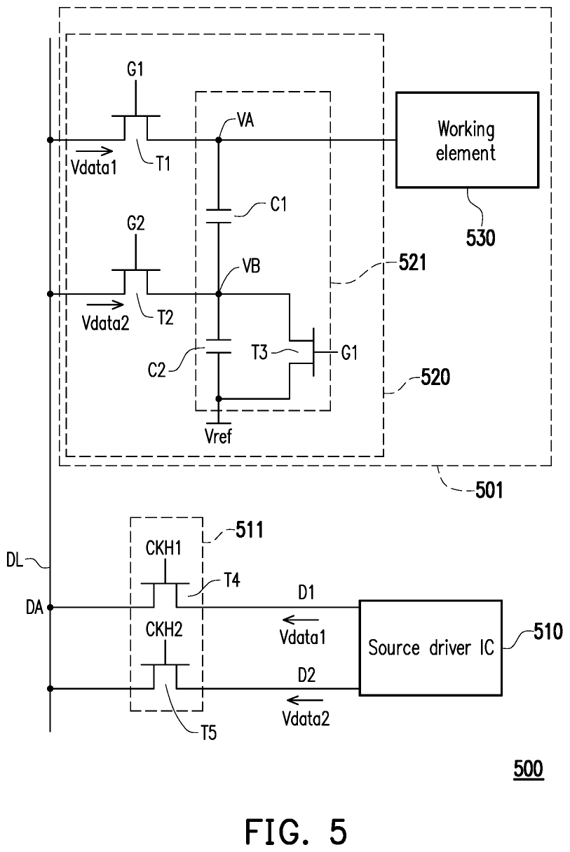

FIG. 5 is a schematic diagram of an electronic device according to an embodiment of the disclosure. Referring to FIG. 5, the electronic device 500 includes a plurality of units, a source driver IC 510, a multiplexer circuit 511, and a data line DL. At least one of the plurality of units may be configured as unit 501. The unit 501 includes a driving circuit 520 and a working element 530. The working element 530 may be a voltage-controlled circuit, such as an LED driver unit or an antenna unit. In the embodiment of the disclosure, the working element 530 is coupled to the driving circuit 520. The source driver IC 510 is coupled to the driving circuit 520 through the multiplexer circuit 511 and the data line DL, and respectively outputs a first data signal D1 and a second data signal D2 through a first terminal and a second terminal. The source driver IC 510 may outputs a first data signal D1 and a second data signal D2 to the driving circuit 520 through the multiplexer circuit 511 and the data line DL. The working element 530 is driven by the driving circuit 520. The driving circuit 520 may sequentially receive the first data signal D1 and the second data signal D2 during a scan period.

In the embodiment of the disclosure, the driving circuit 520 may include a first transistor T1, a second transistor T2, and a voltage adder 521. The voltage adder 521 may include a first capacitor C1, a second capacitor C2, and a third transistor T3. A first terminal of the first transistor T1 is coupled to the data line DL to receive the first data signal D1, and a second terminal of the first transistor T1 is coupled to a first circuit node. A first terminal of the second transistor T2 is coupled to the data line DL to receive the second data signal D2, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 530 is coupled to the first circuit node. In the embodiment of the disclosure, the multiplexer circuit 511 includes a fourth transistor T4 and a fifth transistor T5. A first terminal of the fourth transistor T4 is coupled to the data line DL, and a second terminal of the fourth transistor T4 is coupled to the source driver IC 510. A first terminal of the fifth transistor T5 is coupled to the data line DL, and a second terminal of the fifth transistor T5 is coupled to the source driver IC 510. The fourth transistor T4 may transmit the first data signal D1 to the data line DL, and the fifth transistor T5 may transmit the second data signal D2 to the data line DL at different times. In the embodiment of the disclosure, the first transistor T1, the second transistor T2, the third transistor T3, the fourth transistor T4, and the fifth transistor T5 may be a N-type transistor, respectively.

In the embodiment of the disclosure, the driving circuit 520 may sequentially receive the first data signal D1 having a data voltage “Vdata1” and the second data signal D2 having a data voltage “Vdata2” at different times. The first transistor T1 and the second transistor T2 may sequentially receive the first data signal D1 and the second data signal D2. Specifically, a control terminal of the first transistor T1 may receive a first control signal G1. A control terminal of the second transistor T2 may receive a second control signal G2. A control terminal of the third transistor T3 may receive the first control signal G1. A control terminal of the fourth transistor T4 may receive the first switching signal CKH1. A control terminal of the fifth transistor T5 may receive the second switching signal CKH2. The second terminal of the first transistor T1 may output the first data signal D1 having the data voltage “Vdata1” to the voltage adder 521 by receiving the first data signal D1 from the fourth transistor T4 according to the first control signal G1 and the first switching signal CKH1. The second terminal of the second transistor T2 may output the second data signal D2 having the data voltage “Vdata2” to the voltage adder 521 by receiving the second data signal D2 from the fifth transistor T5 according to the second control signal G2 and the second switching signal CKH2. The voltage adder 521 may output a driving signal to the working element 530. Therefore, the working element 530 is driven by the driving signal, and the driving signal has a voltage higher than the data voltage “Vdata1” of the first data signal D1 and the data voltage “Vdata2” of the second data signal D2.

In addition, referring previously embodiment of FIG. 3 again, in one embodiment of the disclosure, the electronic device 300 may further include a demultiplexer circuit, and the demultiplexer circuit includes a fourth transistor and a fifth transistor (similar to the fourth transistor T4 and fifth transistor T5 of FIG. 5) coupled between one terminal of the source driver IC 310 and the first data line DL1 and the second data line DL2, respectively. Thus, the source driver IC 310 may output the data signal having the data voltage “Vdata1” and the data voltage “Vdata2” in different times, so the first transistor T1 and the second transistor T2 of FIG. 3 may sequentially receive the first data signal D1 and the second data signal D2 based on the switching of the demultiplexer circuit.

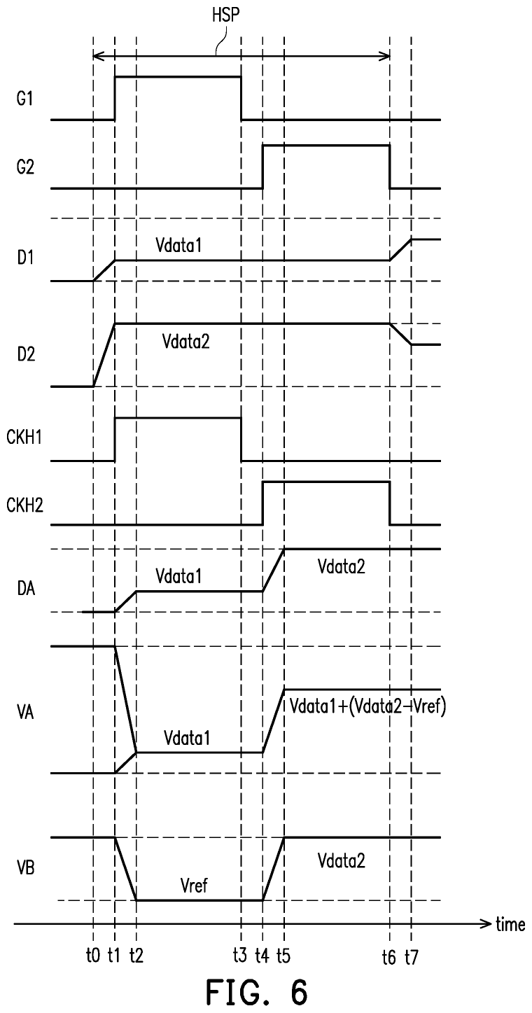

FIG. 6 is a schematic timing diagram of a plurality of voltages and signals according to the embodiment of FIG. 5 of the disclosure. Referring to FIG. 5 and FIG. 6, the plurality of voltages and signals associated with the electronic device 500 of FIG. 5 may be implemented as shown in the timing diagram of FIG. 6. In the embodiment of the disclosure, the source driver IC 510 may output the first data signal D1 and the second data signal D2 to the multiplexer circuit 511 at the same time. During the period from time t0 to time t1, the first data signal D1 is raised to the data voltage “Vdata1”, and the second data signal D2 is raised to the data voltage “Vdata2”. During the period from time t1 to time t2, the first control signal G1 and the first switching signal CKH1 are changed to a high voltage level, and the second control signal G2 and the second switching signal CKH2 are maintained at a low voltage level. The first data signal D1 is maintained at the data voltage “Vdata1”. The second data signal D2 is maintained at the data voltage “Vdata2”. Thus, the first transistor T1 is turned-on, the second transistor T2 is turned-off, the third transistor T3 is turned-on, the fourth transistor T4 is turned-on, and the fifth transistor T5 is turned-off. A node voltage VA of the first circuit node is changed to the data voltage “Vdata1”. A node voltage VB of the second circuit node is changed to the reference voltage Vref.

During the period from time t2 to time t3, the first control signal G1 and the first switching signal CKH1 are maintained at the high voltage level, and the second control signal G2 the second switching signal CKH2 are maintained at the low voltage level. The node voltage VA of the first circuit node is maintained at the data voltage “Vdata1”. The node voltage VB of the second circuit node is maintained at the reference voltage Vref. The first data signal D1 is maintained at the data voltage “Vdata1”. The second data signal D2 is maintained at the data voltage “Vdata2”. Thus, the first capacitor C1 and the second capacitor C2 are charged during the period from time t2 to time t3.

During the period from time t3 to time t4, the first control signal G1 and the first switching signal CKH1 are changed to the low voltage level, and the second control signal G2 and the second switching signal CKH2 are maintained at the low voltage level. Thus, the first transistor T1, the second transistor T2, the third transistor T3, the fourth transistor T4 and the fifth transistor T5 are turned-off. The first data signal D1 is maintained at the data voltage “Vdata1”. The second data signal D2 is maintained at the data voltage “Vdata2”. Due to the first capacitor C1, the node voltage VA of the first circuit node is maintained at the data voltage “Vdata1”. Due to the second capacitor C2, the node voltage VB of the second circuit node is maintained at the reference voltage Vref.

During the period from time t4 to time t5, the first control signal G1 and the first switching signal CKH1 are maintained at the low voltage level, and the second control signal G2 and the second switching signal CKH2 are changed to the high voltage level. The first data signal D1 is maintained at the data voltage “Vdata1”. The second data signal D2 is maintained at the data voltage “Vdata2”. Thus, the first transistor T1 is turned-off, the second transistor T2 is turned-on, the third transistor T3 is turned-off, the fourth transistor T4 is turned-off, and the fifth transistor T5 is turned-on. The node voltage VB of the second circuit node is changed to the data voltage “Vdata2”. Due to the node voltage VB of a terminal of first capacitor C1 is raised to the data voltage “Vdata2”, the first capacitor C1 is charged, so that the node voltage VA of another terminal of first capacitor C1 is raised to the data voltage “Vdata1+(Vdata2−Vref)”.

During the period from time t5 to time t6, the first control signal G1 and the first switching signal CKH1 are maintained at the low voltage level, and the second control signal G2 and the second switching signal CKH2 are maintained at the high voltage level. The first data signal D1 is maintained at the data voltage “Vdata1”. The second data signal D2 is maintained at the data voltage “Vdata2”. Thus, the first transistor T1 is turned-off, the second transistor T2 is turned-on, the third transistor T3 is turned-off, the fourth transistor T4 is turned-off, and the fifth transistor T5 is turned-on. The node voltage VB of the second circuit node is maintained at the data voltage “Vdata2”. Due to the node voltage VB of the terminal of first capacitor C1 is maintained at the data voltage “Vdata2”, the node voltage VA of the another terminal of first capacitor C1 is maintained at the data voltage “Vdata1+(Vdata2−Vref)”. Therefore, the voltage adder 521 may output the driving signal having the data voltage “Vdata1+(Vdata2−Vref)” to drive the working element 530 through the first circuit node.

During the period from time t6 to time t7, the first control signal G1 and the first switching signal CKH1 are maintained at the low voltage level, and the second control signal G2 and the second switching signal CKH2 are changed to the low voltage level. Thus, the first transistor T1 is turned-off, the second transistor T2 is turned-off, and the third transistor T3 is turned-off, the fourth transistor T4 is turned-off, and the fifth transistor T5 is turned-off. The node voltage VB of the second circuit node is maintained at the data voltage “Vdata2”, and the node voltage VA of the another terminal of first capacitor C1 is maintained at the data voltage “Vdata1+(Vdata2−Vref)”.

In addition, the period from time t0 to time t7 may be one scan period of the electronic device 500. Moreover, due to the source driver IC 510 provides the first data signal D1 and the second data signal D2 through the first data line DL1 and the second data line DL2 at the same time, the period from time t0 to time t6 may be one horizontal scan period HSP of the source driver IC 510 for outputting the first data signal D1 having the data voltage “Vdata1” and the second data signal D2 having the data voltage “Vdata2”.

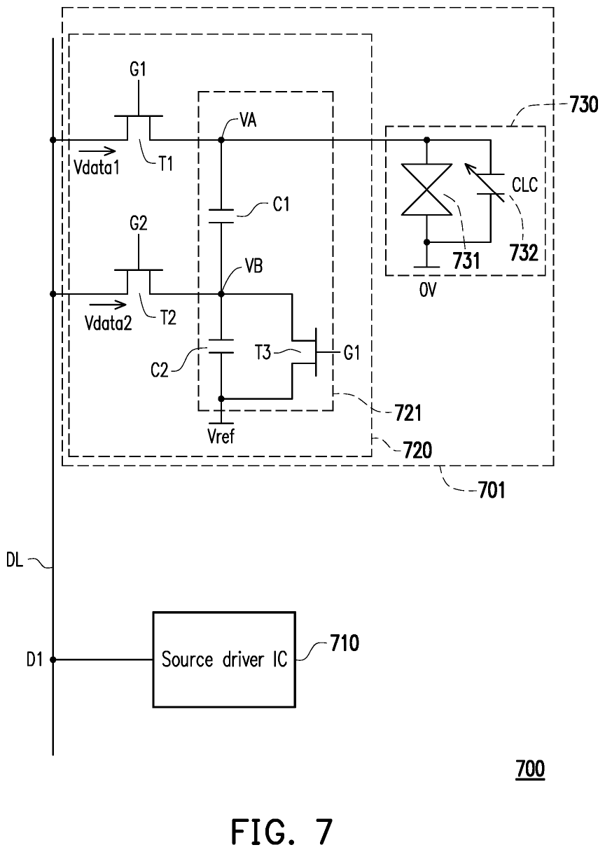

FIG. 7 is a schematic diagram of an electronic device according to a first application embodiment of the disclosure. Referring to FIG. 7, the electronic device 700 includes a plurality of units, a source driver IC 710, and a data line DL. At least one of the plurality of units may be configured as unit 701. The unit 701 includes a driving circuit 720 and a working element 730. The working element 730 may be a circuit of liquid-crystal, and include a liquid-crystal unit 731 and a variable capacitance 732. In the embodiment of the disclosure, the working element 730 is coupled to the driving circuit 720. The source driver IC 710 is coupled to the driving circuit 720 through the data line DL, and provides a data signal D1 to the driving circuit 720 through the data line DL. The working element 730 is driven by the driving circuit 720. The driving circuit 720 may receive a first data signal and a second signal during a scan period.

In the embodiment of the disclosure, the driving circuit 720 may include a first transistor T1, a second transistor T2, and a voltage adder 721. The voltage adder 721 may include a first capacitor C1, a second capacitor C2, and a third transistor T3. A first terminal of the first transistor T1 is coupled to the data line DL, and a second terminal of the first transistor T1 is coupled to a first circuit node. A first terminal of the second transistor T2 is coupled to the data line DL, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 730 is coupled to the first circuit node. In the embodiment of the disclosure, the first transistor T1, the second transistor T2, and the third transistor T3 may be an N-type transistor, respectively. In the embodiment of the disclosure, a first terminal of the liquid crystal unit 731 is coupled to the first circuit node, and the second terminal of the liquid crystal unit 731 is coupled to a ground voltage (0V). A first terminal of the variable capacitance 732 is coupled to the first terminal of the liquid crystal unit 731, and the second terminal of the variable capacitance 732 is coupled to the ground voltage (0V).

In the embodiment of the disclosure, the driving circuit 720 may sequentially receive the first data signal having a data voltage “Vdata1” and the second data signal having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal having the data voltage “Vdata1” and the second data signal having the data voltage “Vdata2” to the voltage adder 721 by respectively receiving the data signal D1 according to the first control signal G1 and the second control signal G2. The voltage adder 721 may output a driving signal to the working element 730.

In the embodiment of the disclosure, the plurality of voltages and signals associated with the electronic device 700 may be implemented as shown in the timing diagram of FIG. 2. The following reference voltage Vref is 0V as an example, when the first transistor T1 is turned-on, the second transistor T2 is turned-off, and the third transistor T3 is turned-on, the first capacitor C1 is changed by the data signal having the data voltage “Vdata1”. Then, when the first transistor T1 is turned-off, the second transistor T2 is turned-on, and the third transistor T3 is turned-off, the second capacitor C2 is changed by the data signal having the data voltage “Vdata2”, thus the node voltage VB of the second circuit node has a data voltage “Vdata2”. Moreover, due to the voltage division of the first capacitor C1 (which may, for example, have capacitance CA) and the variable capacitance 732 (which may, for example, have capacitance CB), the node voltage VA of the first circuit node has a data voltage “Vdata1+(CA/(CA+CB))× Vdata2”. Therefore, the liquid crystal unit 731 may be driven by the driving signal having the data voltage “Vdata1+(CA/(CA+CB))×Vdata2”.

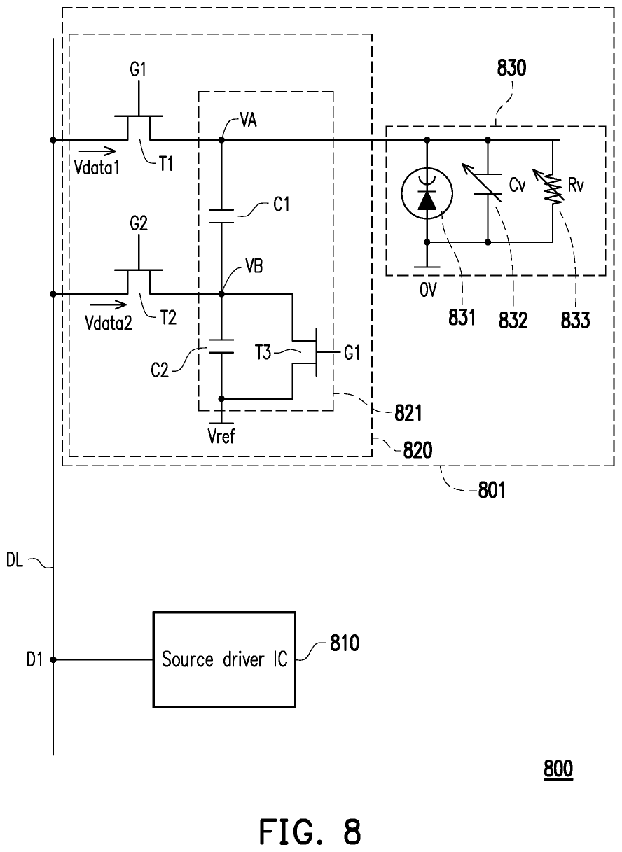

FIG. 8 is a schematic diagram of an electronic device according to a second application embodiment of the disclosure. Referring to FIG. 8, the electronic device 800 includes a plurality of units, a source driver IC 810, and a data line DL. At least one of the plurality of units may be configured as unit 801. The unit 801 includes a driving circuit 820 and a working element 830. The working element 830 may be an antenna unit, and include a varactor 831, a varactor capacitance 832 (Cv), and a varactor resistance 833 (Rv). In the embodiment of the disclosure, the working element 830 is coupled to the driving circuit 820. The source driver IC 810 is coupled to the driving circuit 820 through the data line DL, and provides a data signal D1 to the driving circuit 820 through the data line DL. The working element 830 is driven by the driving circuit 820. The driving circuit 820 may receive a first data signal and a second signal during a scan period.

In the embodiment of the disclosure, the driving circuit 820 may include a first transistor T1, a second transistor T2, and a voltage adder 821. The voltage adder 821 may include a first capacitor C1, a second capacitor C2, and a third transistor T3. A first terminal of the first transistor T1 is coupled to the data line DL, and a second terminal of the first transistor T1 is coupled to a first circuit node. A first terminal of the second transistor T2 is coupled to the data line DL, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 830 is coupled to the first circuit node. In the embodiment of the disclosure, the first transistor T1, the second transistor T2, and the third transistor T3 may be an N-type transistor, respectively. In the embodiment of the disclosure, a first terminal of the varactor 831 is coupled to the first circuit node, and a second terminal of the varactor 831 is coupled to a ground voltage (0V). A first terminal of the varactor capacitance 832 is coupled to the first terminal of the varactor 831, and a second terminal of the varactor capacitance 832 is coupled to the ground voltage (0V). A first terminal of the varactor resistance 833 is coupled to the first terminal of the varactor 831, and a second terminal of the varactor resistance 833 is coupled to the ground voltage (0V).

In the embodiment of the disclosure, the driving circuit 820 may sequentially receive the first data signal having a data voltage “Vdata1” and the second data signal having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal having the data voltage “Vdata1” and the second data signal having the data voltage “Vdata2” to the voltage adder 821 by respectively receiving the data signal D1 according to the first control signal G1 and the second control signal G2. The voltage adder 821 may output a driving signal to the working element 830.

In the embodiment of the disclosure, the plurality of voltages and signals associated with the electronic device 800 may be implemented as shown in the timing diagram of FIG. 2. The following reference voltage Vref is 0V as an example, when the first transistor T1 is turned-on, the second transistor T2 is turned-off, and the third transistor T3 is turned-on, the first capacitor C1 is changed by the data signal having the data voltage “Vdata1”. Then, when the first transistor T1 is turned-off, the second transistor T2 is turned-on, and the third transistor T3 is turned-off, the second capacitor C2 is changed by the data signal having the data voltage “Vdata2”, thus the node voltage VB of the second circuit node has a data voltage “Vdata2”. Moreover, due to the voltage drop by the varactor resistance 833 (which may, for example, have voltage dv) and the voltage division of the first capacitor C1 (which may, for example, have capacitance CA) and the varactor capacitance 832 (which may, for example, have capacitance CV), the node voltage VA of the first circuit node has a data voltage “Vdata1+(CA/(CA+CV))×Vdata2−dv”. Therefore, the varactor 831 may be driven by the driving signal having the data voltage “Vdata1+(CA/(CA+CV))×Vdata2−dv”.

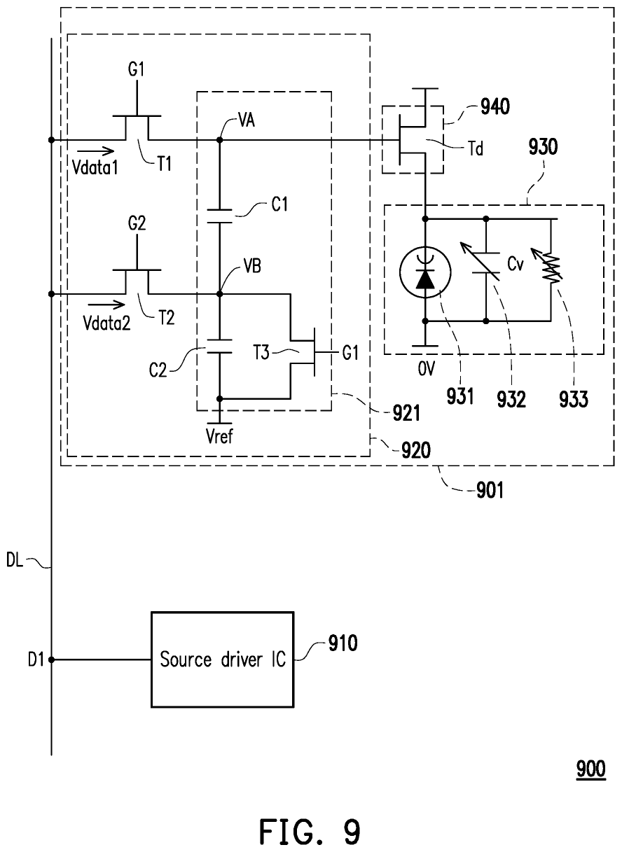

FIG. 9 is a schematic diagram of an electronic device according to a third application embodiment of the disclosure. Referring to FIG. 9, the electronic device 900 includes a plurality of units, a source driver IC 910, and a data line DL. At least one of the plurality of units may be configured as unit 901. The unit 901 includes a driving circuit 920, a working element 930, and a source follower voltage amplifier 940. The working element 930 may be an antenna unit, and include a varactor 931, a varactor capacitance 932 (Cv), and a varactor resistance 933 (Rv). The source follower voltage amplifier 940 includes a transistor Td. In the embodiment of the disclosure, the working element 930 is coupled to the source follower voltage amplifier 940, and the source follower voltage amplifier 940 is further coupled to the driving circuit 920. The source driver IC 910 is coupled to the driving circuit 920 through the data line DL, and provides a data signal D1 to the driving circuit 920 through the data line DL. The working element 930 is driven by the driving circuit 920 and the source follower voltage amplifier 940. The driving circuit 920 may receive a first data signal and a second signal during a scan period.

In the embodiment of the disclosure, the driving circuit 920 may include a first transistor T1, a second transistor T2, and a voltage adder 921. The voltage adder 921 may include a first capacitor C1, a second capacitor C2, and a third transistor T3. A first terminal of the first transistor T1 is coupled to the data line DL, and a second terminal of the first transistor T1 is coupled to a first circuit node. A first terminal of the second transistor T2 is coupled to the data line DL, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. A first terminal of the transistor Td is coupled to an operation voltage, and the second terminal is coupled to the working element 930. The control terminal of the transistor Td is coupled to the first circuit node. In the embodiment of the disclosure, the first transistor T1, the second transistor T2, the third transistor T3, and the transistor Td may be a N-type transistor, respectively. In the embodiment of the disclosure, a first terminal of the varactor 931 is coupled to the second terminal of the transistor Td, and a second terminal of the varactor 931 is coupled to a ground voltage (0V). A first terminal of the varactor capacitance 932 is coupled to the first terminal of the varactor 931, and a second terminal of the varactor capacitance 932 is coupled to the ground voltage (0V). A first terminal of the varactor resistance 933 is coupled to the first terminal of the varactor 931, and a second terminal of the varactor resistance 933 is coupled to the ground voltage (0V).

In the embodiment of the disclosure, the driving circuit 920 may sequentially receive the first data signal having a data voltage “Vdata1” and the second data signal having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal having the data voltage “Vdata1” and the second data signal having the data voltage “Vdata2” to the voltage adder 921 by respectively receiving the data signal D1 according to the first control signal G1 and the second control signal G2. The voltage adder 921 may output a driving signal to the transistor Td, so as to control the transistor Td to drive the working element 930.

In the embodiment of the disclosure, the plurality of voltages and signals associated with the electronic device 900 may be implemented as shown in the timing diagram of FIG. 2. The following reference voltage Vref is 0V as an example, when the first transistor T1 is turned-on, the second transistor T2 is turned-off, and the third transistor T3 is turned-on, the first capacitor C1 is changed by the data signal having the data voltage “Vdata1”. Then, when the first transistor T1 is turned-off, the second transistor T2 is turned-on, and the third transistor T3 is turned-off, the second capacitor C2 is changed by the data signal having the data voltage “Vdata2”, thus the node voltage VB of the second circuit node has a data voltage “Vdata2”, thus the node voltage VA of the first circuit node has a data voltage “Vdata1+Vdata2”. Moreover, due to the threshold voltage “Vth” of the transistor Td and the voltage drop by the varactor resistance 933 (which may, for example, have voltage dv), the second terminal of the transistor Td may have a terminal voltage “Vdata1+Vdata2−|Vth|−dv”. Therefore, the varactor 931 may be driven by the driving signal having the data voltage “Vdata1+Vdata2−|Vth|−dv”.

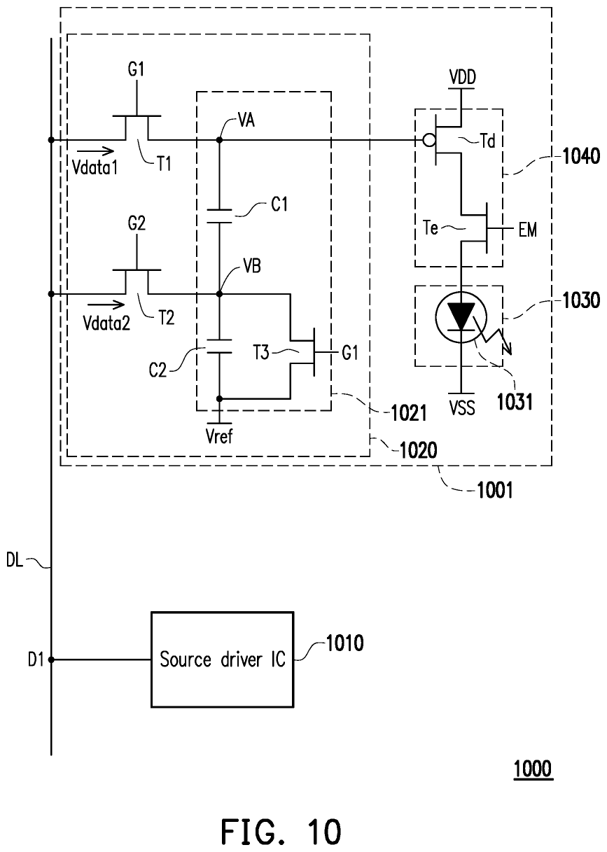

FIG. 10 is a schematic diagram of an electronic device according to a fourth application embodiment of the disclosure. Referring to FIG. 10, the electronic device 1000 includes a plurality of units, a source driver IC 1010, and a data line DL. At least one of the plurality of units may be configured as unit 1001. The unit 1001 includes a driving circuit 1020, a working element 1030, and a current driver 1040. The working element 1030 may be a current-controlled device, and includes an LED unit 1031. The current driver 1040 includes a transistor Td and a transistor Te. In the embodiment of the disclosure, the working element 1030 is coupled to the current driver 1040, and the current driver 1040 is further coupled to the driving circuit 1020. The source driver IC 1010 is coupled to the driving circuit 1020 through the data line DL, and provides a data signal D1 to the driving circuit 1020 through the data line DL. The working element 1030 is driven by the driving circuit 1020 and the current driver 1040. The driving circuit 1020 may receive a first data signal and a second signal during a scan period.

In the embodiment of the disclosure, the driving circuit 1020 may include a first transistor T1, a second transistor T2, and a voltage adder 1021. The voltage adder 1021 may include a first capacitor C1, a second capacitor C2, and a third transistor T3. A first terminal of the first transistor T1 is coupled to the data line DL, and a second terminal of the first transistor T1 is coupled to a first circuit node. A first terminal of the second transistor T2 is coupled to the data line DL, and a second terminal of the second transistor T2 is coupled to a second circuit node. The first capacitor C1 is coupled between the second terminal of the first transistor T1 (the first circuit node) and the second terminal of the second transistor T2 (the second circuit node) through the first circuit node and the second circuit node. The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. A first terminal of the transistor Td is coupled to a first operation voltage, and a second terminal is coupled to the working element 1030. The control terminal of the transistor Td is coupled to the first circuit node. In the embodiment of the disclosure, the first transistor T1, the second transistor T2, and the transistor Te may be an N-type transistor, respectively. The transistor Td and the third transistor T3 may be a P-type transistor, respectively. In the embodiment of the disclosure, a first terminal of the LED unit 1031 is coupled to the second terminal of the transistor Td, and a second terminal of the LED unit 1031 is coupled to a second operation voltage VSS.

In the embodiment of the disclosure, the driving circuit 1020 may sequentially receive the first data signal having a data voltage “Vdata1” and the second data signal having a data voltage “Vdata2”. Specifically, a control terminal of the first transistor T1 may receive a first control signal G1. A control terminal of the second transistor T2 may receive a second control signal G2. A control terminal of the third transistor T3 may receive the first control signal G1. The second terminals of the first transistor T1 and the second transistor T2 may output the first data signal having the data voltage “Vdata1” and the second data signal having the data voltage “Vdata2” to the voltage adder 1021 by respectively receiving the data signal D1 according to the first control signal G1 and the second control signal G2. The voltage adder 1021 may output a driving signal to the transistor Td, so as to control the transistor Td to drive the working element 930 when the transistor Te is turned-on by an emission signal EM.

In the embodiment of the disclosure, the plurality of voltages and signals associated with the electronic device 1000 may be implemented as shown in the timing diagram of FIG. 2. The following reference voltage Vref is 0V as an example, when the first transistor T1 is turned-on, the second transistor T2 is turned-off, and the third transistor T3 is turned-on, the first capacitor C1 is changed by the data signal having the data voltage “Vdata1”. Then, when the first transistor T1 is turned-off, the second transistor T2 is turned-on, and the third transistor T3 is turned-off, the second capacitor C2 is changed by the data signal having the data voltage “Vdata2”, thus the node voltage VB of the second circuit node has a data voltage “Vdata2”, thus the node voltage VA of the first circuit node has a data voltage “Vdata1+Vdata2”. Therefore, the LED unit 1031 may be driven by a current provided by the transistor Td controlled by the voltage “Vdata1+Vdata2”.

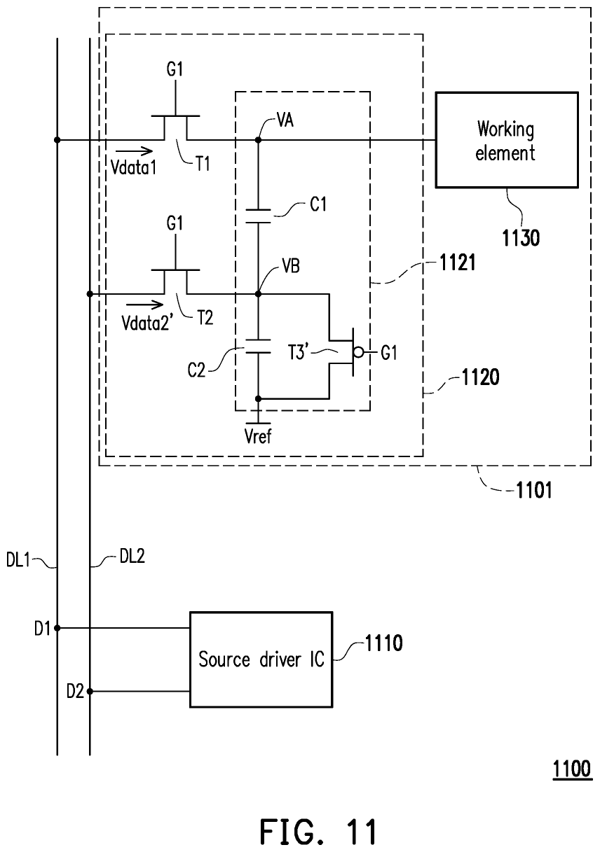

FIG. 11 is a schematic diagram of an electronic device according to an embodiment of the disclosure. Referring to FIG. 11, the electronic device 1100 includes a plurality of units, a source driver IC 1110, a first date lain DL1 and a second data line DL2. At least one of the plurality of units may be configured as unit 1101. The unit 1101 includes a driving circuit 1120 and a working element 1130. The working element 1130 may be a voltage-controlled circuit, such as an LED driver unit or an antenna unit. In the embodiment of the disclosure, the working element 1130 is coupled to the driving circuit 1120. The source driver IC 1110 is coupled to the driving circuit 1120 through the first data line DL1 and the second data line DL2, and outputs a first data signal D1 and a second data signal D2 to the driving circuit 1120 through the first data line DL1 (first terminal) and the second data line DL2 (second terminal). The working element 1130 is driven by the driving circuit 1120. The driving circuit 1120 may receive the first data signal D1 and the second data signal D2 at the same time during a scan period.

In the embodiment of the disclosure, the driving circuit 1120 may include a first transistor T1, a second transistor T2, and a voltage adder 1121. The voltage adder 1121 may include a first capacitor C1, a second capacitor C2, and a third transistor T3′, where the second capacitor C2 may be optional. A first terminal of the first transistor T1 is coupled to the first data line DL1 to receive the first data signal D1, and a second terminal of the first transistor T1 is coupled to a first circuit node. A first terminal of the second transistor T2 is coupled to the second data line DL2 to receive the second data signal D2, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 1130 is coupled to the first circuit node. In the embodiment of the disclosure, the first transistor T1, and the second transistor T2 may be an N-type transistor, respectively. The third transistor T3 may be a P-type transistor.

In the embodiment of the disclosure, the driving circuit 1120 may simultaneously receive the first data signal D1 having a data voltage “Vdata1” and the second data signal D2 having a data voltage “Vdata2′”. Specifically, a control terminal of the first transistor T1 may receive a first control signal G1. A control terminal of the second transistor T2 may receive the first control signal G1. A control terminal of the third transistor T3 may receive the first control signal G1. The second terminals of the first transistor T1 and the second transistor T2 may output the first data signal D1 having the data voltage “Vdata1” and the second data signal D2 having the data voltage “Vdata2′” to the voltage adder 1121 by respectively receiving the first data signal D1 according to the first control signal G1. The voltage adder 1121 may output a driving signal to the working element 1130. Therefore, the working element 1130 is driven by the driving signal, and the driving signal has a voltage higher than the data voltage “Vdata1” of the first data signal D1 and the data voltage “Vdata2′” of the second data signal D2. It should be noted that, the data voltage “Vdata2′” may equal to the reference voltage Vref minus the data voltage “Vdata2” (Vdata2′=Vref-Vdata2), and the data voltage “Vdata2′” may be less than the reference voltage Vref.

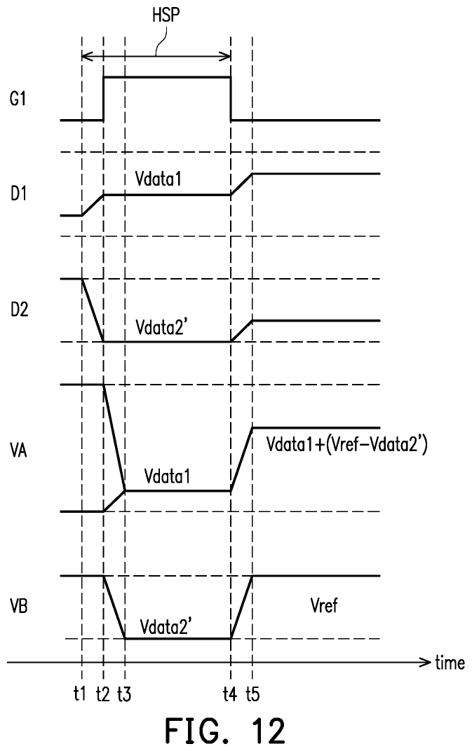

FIG. 12 is a schematic timing diagram of a plurality of voltages and signals according to the embodiment of FIG. 11 of the disclosure. Referring to FIG. 11 and FIG. 12, the plurality of voltages and signals associated with the electronic device 1100 of FIG. 11 may be implemented as shown in the timing diagram of FIG. 12. In the embodiment of the disclosure, the source driver IC 1110 may output the first data signal D1 and the second data signal D2 to the first data line DL1 and the second data line DL2 at the same time. During the period from time t1 to time t2, the first data signal D1 is raised to the data voltage “Vdata1”, and the second data signal D2 is falling to the data voltage “Vdata2′”. During the period from time t2 to time t3, the first control signal G1 is changed to a high voltage level. The first data signal D1 is maintained at the data voltage “Vdata1”. The second data signal D2 is maintained at the data voltage “Vdata2′”. Thus, the first transistor T1 is turned-on, the second transistor T2 is turned-on, and the third transistor T3′ is turned-off. A node voltage VA of the first circuit node is changed to the data voltage “Vdata1”. A node voltage VB of the second circuit node is changed to the data voltage “Vdata2′”.

During the period from time t3 to time t4, the first control signal G1 is maintained at the high voltage level. The node voltage VA of the first circuit node is maintained at the data voltage “Vdata1”. The node voltage VB of the second circuit node is maintained at the data voltage “Vdata2′”. The first data signal D1 is maintained at the data voltage “Vdata1”. The second data signal D2 is maintained at the data voltage “Vdata2′”. Thus, the first capacitor C1 and the second capacitor C2 are charged during the period from time t3 to time t4.

During the period from time t4 to time t5, the first control signal G1 is changed to the low voltage level. Thus, the first transistor T1 is turned-off, the second transistor T2 is turned-off, and the third transistor T3′ is turned-on. Due to the second capacitor C2 is charged by the reference voltage Vref, the node voltage VB of the second circuit node is charged to the reference voltage Vref, and the node voltage VA of the first circuit node is charged to the data voltage “Vdata1+(Vref−Vdata2′)” (i.e., Vdata1+Vref−Vref+Vdata2=Vdata1+Vdata2). Therefore, after time t5, the voltage adder 1121 may output the driving signal having the data voltage “Vdata1+Vdata2” to drive the working element 1130 through the first circuit node.

In addition, due to the source driver IC 1110 provides the first data signal D1 and the second data signal D2 through the first data line DL1 and the second data line DL2 at the same time, the period from time t1 to time t4 may be one horizontal scan period HSP of the source driver IC 1110 for outputting the first data signal D1 having the data voltage “Vdata1” and the second data signal D2 having the data voltage “Vdata2′”.

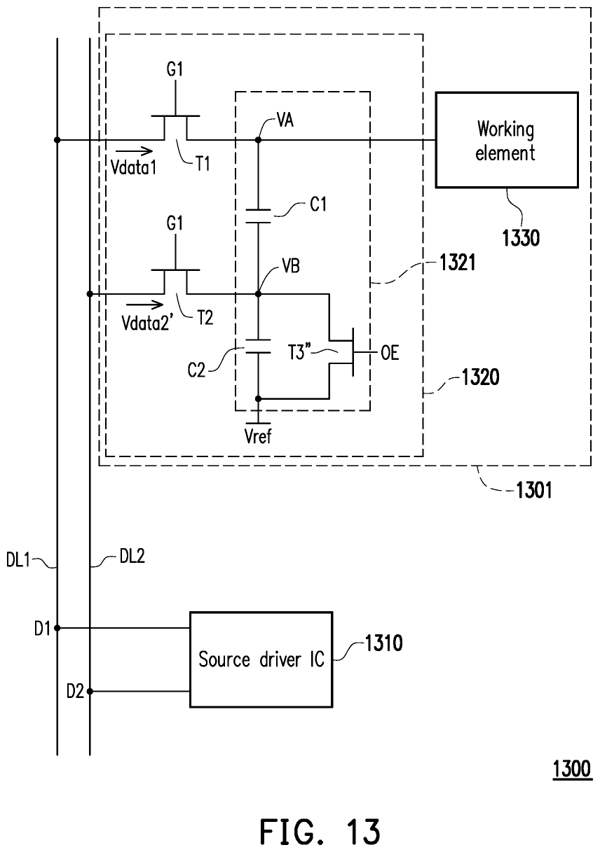

FIG. 13 is a schematic diagram of an electronic device according to an embodiment of the disclosure. Referring to FIG. 13, the electronic device 1300 includes a plurality of units, a source driver IC 1310, a first date lain DL1 and a second data line DL2. At least one of the plurality of units may be configured as unit 1301. The unit 1301 includes a driving circuit 1320 and a working element 1330. The working element 1330 may be a voltage-controlled circuit, such as a LED driver unit or an antenna unit. In the embodiment of the disclosure, the working element 1330 is coupled to the driving circuit 1320. The source driver IC 1310 is coupled to the driving circuit 1320 through the first data line DL1 and the second data line DL2, and outputs a first data signal D1 and a second data signal D2 to the driving circuit 1320 through the first data line DL1 (first terminal) and the second data line DL2 (second terminal). The working element 1330 is driven by the driving circuit 1320. The driving circuit 1320 may receive the first data signal D1 and the second data signal D2 at the same time during a scan period.

In the embodiment of the disclosure, the driving circuit 1320 may include a first transistor T1, a second transistor T2, and a voltage adder 1321. The voltage adder 1321 may include a first capacitor C1, a second capacitor C2, and a third transistor T3″. In one embodiment of the disclosure, the second capacitor C2 may be optional. A first terminal of the first transistor T1 is coupled to the first data line DL1 to receive the first data signal D1, and a second terminal of the first transistor T1 is coupled to a first circuit node. A first terminal of the second transistor T2 is coupled to the second data line DL2 to receive the second data signal D2, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3″ is coupled to the second terminal of the second transistor T2 (the second circuit node), and a second terminal of the third transistor T3″ is coupled to the reference voltage Vref. The working element 1330 is coupled to the first circuit node. In the embodiment of the disclosure, the first transistor T1, the second transistor T2, and third transistor T3″ may be an N-type transistor, respectively.

In the embodiment of the disclosure, the driving circuit 1320 may simultaneously receive the first data signal D1 having a data voltage “Vdata1” and the second data signal D2 having a data voltage “Vdata2′”. Specifically, a control terminal of the first transistor T1 may receive a first control signal G1. A control terminal of the second transistor T2 may receive the first control signal G1. A control terminal of the third transistor T3″ may receive a third control signal OE. The second terminals of the first transistor T1 and the second transistor T2 may output the first data signal D1 having the data voltage “Vdata1” and the second data signal D2 having the data voltage “Vdata2′” to the voltage adder 1321 by respectively receiving the first data signal D1 and the second data signal D2 according to the first control signal G1 and the third control signal OE. The voltage adder 1321 may output a driving signal to the working element 1330. Therefore, the working element 1330 is driven by the driving signal, and the driving signal has a voltage higher than the data voltage “Vdata1” of the first data signal D1 and the data voltage “Vdata2′” of the second data signal D2. It should be noted that, the data voltage “Vdata2′” may equal to the reference voltage Vref minus the data voltage “Vdata2” (i.e., Vdata2′=Vref−Vdata2), and the data voltage “Vdata2′” may be less than the reference voltage Vref.

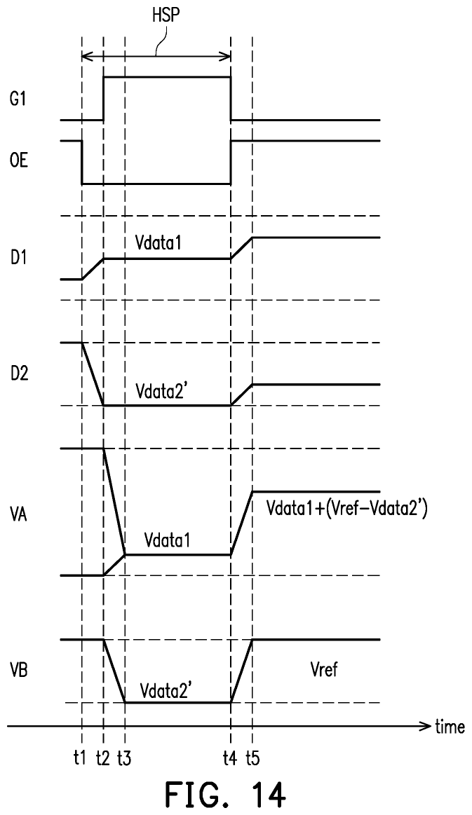

FIG. 14 is a schematic timing diagram of a plurality of voltages and signals according to the embodiment of FIG. 13 of the disclosure. Referring to FIG. 13 and FIG. 14, the plurality of voltages and signals associated with the electronic device 1300 of FIG. 13 may be implemented as shown in the timing diagram of FIG. 14. In the embodiment of the disclosure, the source driver IC 1310 may output the first data signal D1 and the second data signal D2 to the first data line DL1 and the second data line DL2 at the same time. During the period from time t1 to time t2 the first data signal D1 is raised to the data voltage “Vdata1”, and the second data signal D2 is falling to the data voltage “Vdata2′”. The third control signal OE is changed to a low voltage level to turn off the third transistor T3. During the period from time t2 to time t3, the first control signal G1 is changed to a high voltage level. The first data signal D1 is maintained at the data voltage “Vdata1”. The second data signal D2 is maintained at the data voltage “Vdata2′”. Thus, the first transistor T1 is turned-on, the second transistor T2 is turned-on, and the third transistor T3″ is turned-off. A node voltage VA of the first circuit node is changed to the data voltage “Vdata1”. A node voltage VB of the second circuit node is changed to the data voltage “Vdata2′”.

During the period from time t3 to time t4, the first control signal G1 is maintained at the high voltage level, and the third control signal OE is maintained at the low voltage level. The node voltage VA of the first circuit node is maintained at the data voltage “Vdata1”. The node voltage VB of the second circuit node is maintained at the data voltage “Vdata2′”. The first data signal D1 is maintained at the data voltage “Vdata1”. The second data signal D2 is maintained at the data voltage “Vdata2′”. Thus, the first capacitor C1 and the second capacitor C2 are charged during the period from time t3 to time t4.

During the period from time t4 to time t5, the first control signal G1 is changed to the low voltage level, and the third control signal OE is changed to the high voltage level. Thus, the first transistor T1 is turned-off, the second transistor T2 is turned-off, and the third transistor T3″ is turned-on. Due to the second capacitor C2 is charged by the reference voltage Vref, the node voltage VB of the second circuit node is charged to the reference voltage Vref, and the node voltage VA of the first circuit node is charged to the data voltage “Vdata1+(Vref−Vdata2′)” (i.e., Vdata1+Vref−Vref+Vdata2=Vdata1+Vdata2). Therefore, after time t5, the voltage adder 1321 may output the driving signal having the data voltage “Vdata1+Vdata2” to drive the working element 1330 through the first circuit node.

In addition, due to the source driver IC 1310 provides the first data signal D1 and the second data signal D2 through the first data line DL1 and the second data line DL2 at the same time, the period from time t1 to time t4 may be one horizontal scan period HSP of the source driver IC 1310 for outputting the first data signal D1 having the data voltage “Vdata1” and the second data signal D2 having the data voltage “Vdata2′”.

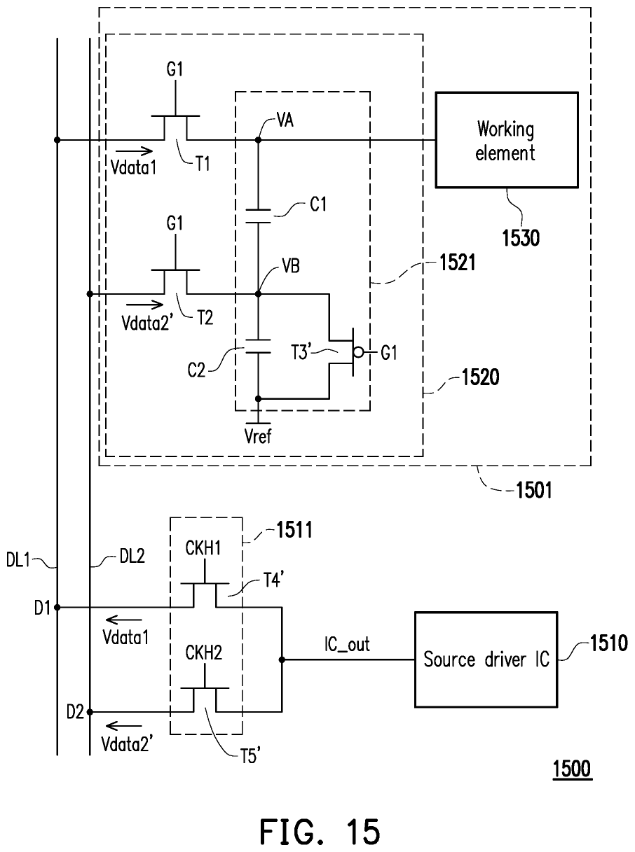

FIG. 15 is a schematic diagram of an electronic device according to an embodiment of the disclosure. Referring to FIG. 15, the electronic device 1500 includes a plurality of units, a source driver IC 1510, a demultiplexer 1511, a first date line DL1 and a second data line DL2. At least one of the plurality of units may be configured as unit 1501. The unit 1501 includes a driving circuit 1520 and a working element 1530. The working element 1530 may be a voltage-controlled circuit, such as an LED driver unit or an antenna unit. In the embodiment of the disclosure, the working element 1530 is coupled to the driving circuit 1520. The source driver IC 1510 is coupled to the driving circuit 1520 through the demultiplexer 1511, the first data line DL1, and the second data line DL2, and sequentially outputs a first data signal D1 and a second data signal D2 through a terminal the demultiplexer. The source driver IC 1510 may output a data signal IC_out including the first data signal D1 or the second data signal D2 to the driving circuit 1520 through the demultiplexer 1511, the first data line DL1 (first terminal) and the second data line DL2 (second terminal). The working element 1530 is driven by the driving circuit 1520. The driving circuit 1520 may simultaneously receive the first data signal D1 and the second data signal D2 at same time during a scan period.

In the embodiment of the disclosure, the driving circuit 1520 may include a first transistor T1, a second transistor T2, and a voltage adder 1521. The voltage adder 1521 may include a first capacitor C1, a second capacitor C2, and a third transistor T3′, where the second capacitor C2 may be optional. A first terminal of the first transistor T1 is coupled to the first data line DL1 to receive the first data signal D1, and a second terminal of the first transistor T1 is coupled to a first circuit node. A first terminal of the second transistor T2 is coupled to the second data line DL2 to receive the second data signal D2, and a second terminal of the second transistor T2 is coupled to a second circuit node. The first capacitor C1 is coupled between the second terminal of the first transistor T1 (the first circuit node) and the second terminal of the second transistor T2 (the second circuit node). The second capacitor C2 is coupled between the second terminal of the second transistor T2 (the second circuit node) and a reference voltage Vref. A first terminal of the third transistor T3 is coupled to the second terminal of the second transistor T2 (the second circuit node), and a second terminal of the third transistor T3 is coupled to the reference voltage Vref. The working element 1530 is coupled to the first circuit node. In the embodiment of the disclosure, the demultiplexer 1511 may include a fourth transistor T4′ and a fifth transistor T5′. A first terminal of the fourth transistor T4′ is coupled to the first data line DL1 for transmitting the first data signal D1 to the first data line DL1, and the second terminal of the fourth transistor T4′ is coupled to the source driver IC 1510. A first terminal of the fifth transistor T5′ is coupled to the second data line DL2 for transmitting the second data signal D2 to the second data line DL2, and the second terminal of the fifth transistor T5′ is coupled to the source driver IC 1510. In the embodiment of the disclosure, the first transistor T1, the second transistor T2, the fourth transistor T4′, and the fifth transistor T5′ may be an N-type transistor, respectively. The third transistor T3′ may be a P-type transistor.

In the embodiment of the disclosure, the driving circuit 1520 may simultaneously receive the first data signal D1 having a data voltage “Vdata1” and the second data signal D2 having a data voltage “Vdata2′”. Specifically, a control terminal of the first transistor T1 may receive a first control signal G1. A control terminal of the second transistor T2 may receive the first control signal G1. A control terminal of the third transistor T3′ may receive the first control signal G1. A control terminal of the fourth transistor T4′ may receive a first switching signal CKH1. A control terminal of the fifth transistor T5′ may receive a second switching signal CKH2.

The second terminals of the fourth transistor T4′ and the fifth transistor T5′ may output the first data signal D1 having the data voltage “Vdata1” and the second data signal D2 having the data voltage “Vdata2′” to the first data line DL1 and the second data line DL2 by respectively receiving the data signal IC_out according to the first switching signal CKH1 and the second switching signal CKH2. It should be noted that, the first data signal D1 and the second data signal D2 may be pre-store in parasitic capacitors on the first data line DL1 and the second data line DL2, respectively. Thus, the first transistor T1 and the second transistor T2 may receive the first data signal D1 and the second data signal D2 at the same time. The second terminals of the first transistor T1 and the second transistor T2 may output the first data signal D1 having the data voltage “Vdata1” and the second data signal D2 having the data voltage “Vdata2′” to the voltage adder 1521 by respectively receiving the first data signal D1 according to the first control signal G1. The voltage adder 1521 may output a driving signal to the working element 1530. Therefore, the working element 1530 is driven by the driving signal, and the driving signal has a voltage higher than the data voltage “Vdata1” of the first data signal D1 and the data voltage “Vdata2′” of the second data signal D2. It should be noted that, the data voltage “Vdata2′” may equal to the reference voltage Vref minus the data voltage “Vdata2” (Vdata2′=Vref−Vdata2), and the data voltage “Vdata2′” may be less than the reference voltage Vref.

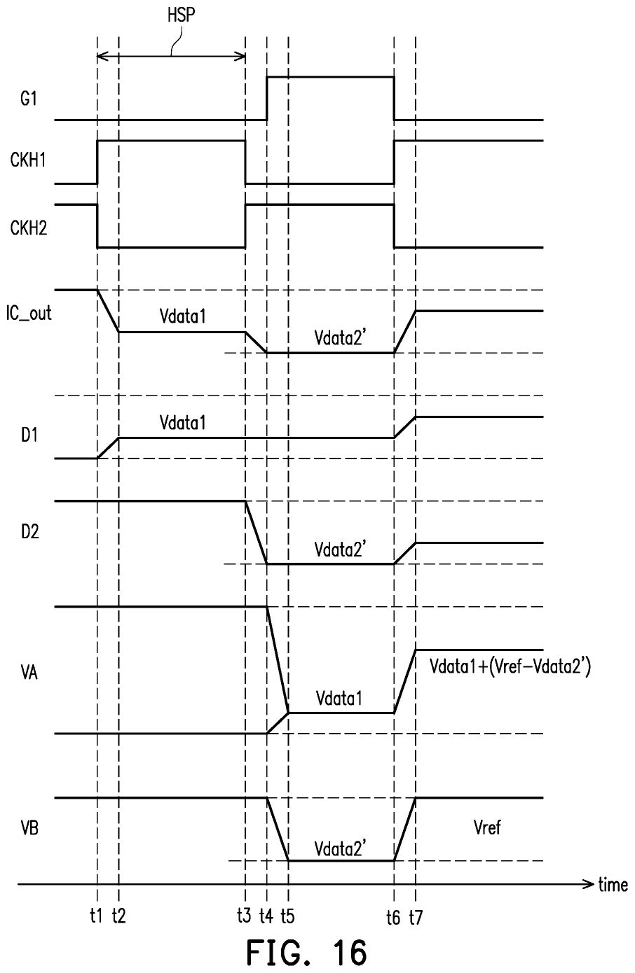

FIG. 16 is a schematic timing diagram of a plurality of voltages and signals according to the embodiment of FIG. 15 of the disclosure. Referring to FIG. 15 and FIG. 16, the plurality of voltages and signals associated with the electronic device 1500 of FIG. 15 may be implemented as shown in the timing diagram of FIG. 16. In the embodiment of the disclosure, the source driver IC 1510 may output the data signal IC_out to the demultiplexer 1511 having a data voltage “Vdata1” or a data voltage “Vdata2′”. During the period from time t1 to time t2, the first control signal G1 is maintained at a low level voltage. The first switching signal CKH1 is changed to a high level voltage, and the second switching signal CKH2 is changed to the low level voltage. Thus, the first transistor T1 is turned-off, the second transistor T2 is turned-off, the third transistor T3′ is turned-on, and the fourth transistor T4′ is turned-on, and the fifth transistor T5′ is turned-off. Due to the data signal IC_out is changed to the data voltage “Vdata1”, so the first data signal D1 is raised to the data voltage “Vdata1” on the first data line DL1. The first data line DL1 has the data voltage “Vdata1”, but a node voltage VA of the first circuit node has no change because the first transistor T1 still turns-off.

During the period from time t2 to time t3, the first control signal G1 is maintained at the low voltage level. The first switching signal CKH1 is maintained at the high level voltage, and the second switching signal CKH2 is maintained at the low level voltage. The first data signal D1 may be pre-store in a parasitic capacitor on the first data line DL1. During the period from time t3 to time t4, the first control signal G1 is maintained at the low voltage level. The first switching signal CKH1 is changed to the low level voltage, and the second switching signal CKH2 is changed to the high level voltage. Thus, the first transistor T1 is turned-off, the second transistor T2 is turned-off, the third transistor T3′ is turned-on, and the fourth transistor T4′ is turned-off, and the fifth transistor T5′ is turned-on. The data signal IC_out is changed to the data voltage “Vdata2′”, so the second data signal D2 is changed to the data voltage “Vdata2′” on the second data line DL2. The second data signal D2 may be pre-store in a parasitic capacitor on the second data line DL2.

During the period from time t4 to time t5, the first control signal G1 is changed to the high voltage level. The first switching signal CKH1 is maintained at the low level voltage, and the second switching signal CKH2 is maintained at the high level voltage. Thus, the first transistor T1 is turned-on, the second transistor T2 is turned-on, the third transistor T3′ is turned-off, and the fourth transistor T4′ is turned-off, and the fifth transistor T5′ is turned-on. The data signal IC_out is maintained at the data voltage “Vdata2′” Due to the first data line DL1 has the data voltage “Vdata1”, a node voltage VA of the first circuit node is changed to the data voltage “Vdata1”. Due to the second data line DL2 has the data voltage “Vdata2′”, a node voltage VB of the second circuit node is changed to the data voltage “Vdata2′”. During the period from time t5 to time t6, the first control signal G1 is maintained at the high voltage level. The first switching signal CKH1 is maintained at the low level voltage, and the second switching signal CKH2 is maintained at the high level voltage. The node voltage VA of the first circuit node is maintained at the data voltage “Vdata1”. The node voltage VB of the second circuit node is maintained at the data voltage “Vdata2′”. Thus, the first capacitor C1 and the second capacitor C2 are charged during the period from time t5 to time t6.

During the period from time t6 to time t7, the first control signal G1 is changed to the low voltage level. The first switching signal CKH1 is changed to the high level voltage, and the second switching signal CKH2 is changed to the low level voltage. Thus, the first transistor T1 is turned-off, the second transistor T2 is turned-off, the third transistor T3′ is turned-on, and the fourth transistor T4′ is turned-on, and the fifth transistor T5′ is turned-off. Due to the second capacitor C2 is charged by the reference voltage Vref, the node voltage VB of the second circuit node is charged to the reference voltage Vref, and the node voltage VA of the first circuit node is charged to the data voltage “Vdata1+(Vref−Vdata2′)” (i.e., Vdata1+Vref−Vref+Vdata2=Vdata1+Vdata2). Therefore, after time t7, the voltage adder 1521 may output the driving signal having the data voltage “Vdata1+Vdata2” to drive the working element 1530 through the first circuit node.

In addition, due to the source driver IC 1510 provides the first data signal D1 and the second data signal D2 through the first data line DL1 and the second data line DL2 in different times, the period from time t1 to time t3 may be one horizontal scan period HSP of the source driver IC 1510 for outputting the first data signal D1 having the data voltage “Vdata1” and the second data signal D2 having the data voltage “Vdata2′”.

In summary, the electronic device of the disclosure is capable of providing a driving signal with a higher driving voltage without redesigning the source driver IC, and may achieve a driving effect with a high dynamic voltage adjustment range.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. An electronic device, comprising:
a plurality of units, wherein at least one of the plurality of units comprises:
a driving circuit, wherein the driving circuit comprises a first transistor, a second transistor, a third transistor and a first capacitor; and
a working element, coupled to the driving circuit, and driven by the driving circuit,
wherein the driving circuit receives a first data signal and a second data signal during a scan period,
wherein a first terminal of the first capacitor is coupled to the first transistor, a second terminal of the first capacitor is coupled to the second transistor and the third transistor.

2. The electronic device according to claim 1, wherein the first transistor is configured to receive the first data signal, and the second transistor is configured to receive the second data signal.

3. The electronic device according to claim 2, wherein the third transistor is coupled to the second transistor.

4. (canceled)

5. The electronic device according to claim 2, wherein the driving circuit further comprises:
a second capacitor, coupled between the second transistor and a reference voltage.

6. The electronic device according to claim 2, wherein the first transistor and the second transistor sequentially receive the first data signal and the second data signal.

7. The electronic device according to claim 6, further comprising:
a first data line, coupled to the first transistor and the second transistor.

8. The electronic device according to claim 7, further comprising:
a source driver integrated circuit, coupled to the first data line, and configured to output the first data signal and the second data signal.

9. The electronic device according to claim 8, further comprising:
a fourth transistor, coupled between the first data line and the source driver integrated circuit, and configured to transmit the first data signal to the first data line; and
a fifth transistor, coupled between the first data line and the source driver integrated circuit, and configured to transmit the second data signal to the first data line.

10. The electronic device according to claim 6, further comprising:
a first data line, coupled to the first transistor; and
a second data line, coupled to the second transistor.

11. The electronic device according to claim 10, further comprising:
a source driver integrated circuit, coupled to the first data line and the second data line, and configured to output a data signal including the first data signal and the second data signal through a terminal.

12. The electronic device according to claim 11, further comprising:
a fourth transistor, coupled between the first data line and the source driver integrated circuit, and configured to output the first data signal to the first data line; and
a fifth transistor, coupled between the second data line and the source driver integrated circuit, and configured to output the second data signal to the second data line.

13. The electronic device according to claim 6, wherein the first transistor and the second transistor receive different control signals.

14. The electronic device according to claim 2, wherein
the first transistor and the second transistor receive the first data signal and the second data signal at an identical time.

15. The electronic device according to claim 14, further comprising:
a first data line, coupled to the first transistor; and
a second data line, coupled to the second transistor.

16. The electronic device according to claim 15, further comprising:
a source driver integrated circuit, coupled to the first data line and the second data line, and configured to output a data signal including the first data signal and the second data signal through a terminal.

17. The electronic device according to claim 16, further comprising:
a fourth transistor, coupled between the first data line and the source driver integrated circuit, and configured to output the first data signal to the first data line; and
a fifth transistor, coupled between the second data line and the source driver integrated circuit, and configured to output the second data signal to the second data line.

18. The electronic device according to claim 15, further comprising:
a source driver integrated circuit, coupled to the first data line and the second data line, and configured to output the first data signal and the second data signal respectively through a first terminal and a second terminal.

19. The electronic device according to claim 14, wherein the first transistor and the second transistor receive a same control signal.

20. The electronic device according to claim 1, wherein the working element is driven by a driving signal, wherein the driving signal has a voltage higher than data voltages of the first data signal and the second data signal.
